(19) United States
(12) Patent Application Publication
(10) Pub. No.: US 2009/0254241 A1
(43) Pub. Date: Oct. 8, 2009

(54) SYSTEM AND METHOD FOR COLLECTING DATA FROM MANY VEHICLES

(76) Inventor: Otman A. Basir, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 12/418,642

(22) Filed: Apr. 6, 2009

Related U.S. Application Data
(60) Provisional application No. 61/042,468, filed on Apr. 4, 2008.

(51) Int. Cl. G06F 19/00; G01S 1/00

(52) U.S. Cl. 701/33; 342/357.09

(57) ABSTRACT

A system and method are provided for collecting data from many vehicles. A vehicle unit with several connectivity options is installed in each vehicle. Each vehicle unit transmits driving characteristic information to a server which records all of the data it receives. In addition, the server is able to interact with the vehicle unit to provide information. A user then requests a particular report or statistic from the server. The server then takes the driving characteristic information from each vehicle including, but not limited to: emissions information, a global navigation satellite system, vehicle brand, geographic area, time of day, crashes, average speed, speed variances, accelerations, acceleration variation, sudden acceleration frequency, sudden deceleration frequency, and car location, and compiles it into data. The server then provides reports and statistics and transmits the report or statistic to the user requesting it.

The application claims priority to U.S. Provisional Application No. 61/042,468 which was filed on Apr. 4, 2008.

### BACKGROUND OF THE INVENTION

This invention relates to a device and method for recording driving characteristics.

The use of data derived from vehicles being driven and known driving tools, such as various road maps, by drivers of the vehicle are well known in the art. GPS devices commonly use this data to employ better route setting techniques. In addition, the use of mobile cellular phone networks can be used to connect vehicles to each other as well as to a larger network of mobile stations creating a network of vehicles.

Business' often are in need of detailed statistics with regards to driving characteristics to increase their own efficiency and effectiveness. There is no access to such statistics, except at the individual vehicle level. For example, it may be possible to monitor emissions based on what is expected from a particular vehicle, but not track precise emissions in a specific area or over a specific time period in more than one vehicle. In another example, an insurance company is able to determine when a crash occurs based on it being reported to them, but does not have knowledge of unreported crashes nor information on the likelihood that a crash would occur in that area.

More particularly, this invention relates to a method and device for recording driving characteristics. These recorded characteristics are then utilized to monitor and compile vehicle usage data which greatly assists in formulating useful driving data such as determining insurance premium, determining traffic, detecting crash events and mapping emissions geographically.

Several current systems provide means to determine some driving characteristics of a particular car. However, these systems have several weaknesses. For one, they utilize cell phone network connectivity only. For another, they do not provide a way of recording data from multiple cars and analyzing it.

### SUMMARY OF THE INVENTION

The present invention provides a system and method for collecting data from many vehicles. The system includes a multitude of vehicles. Each vehicle includes a vehicle unit with several connectivity options. Each vehicle unit transmits driving characteristic information to a server which records all of the data it receives. In addition, the server is able to interact with the vehicle unit to provide information.

A user then requests a particular report or statistic from the server. The server then takes the driving characteristic information from each vehicle including, but not limited to: emissions information, a global navigation satellite system, vehicle brand, geographic area, time of day, crashes, average speed, speed variances, accelerations, acceleration variation, sudden acceleration frequency, sudden deceleration frequency, and car location, and compiles it into data. The server then provides reports and statistics and transmits the report or statistic to the user requesting it.

### BRIEF DESCRIPTION OF THE DRAWINGS

FIG. 1 is a schematic view of the multi-vehicle data collection system and method of the present invention.

### DETAILED DESCRIPTION OF THE PREFERRED EMBODIMENT

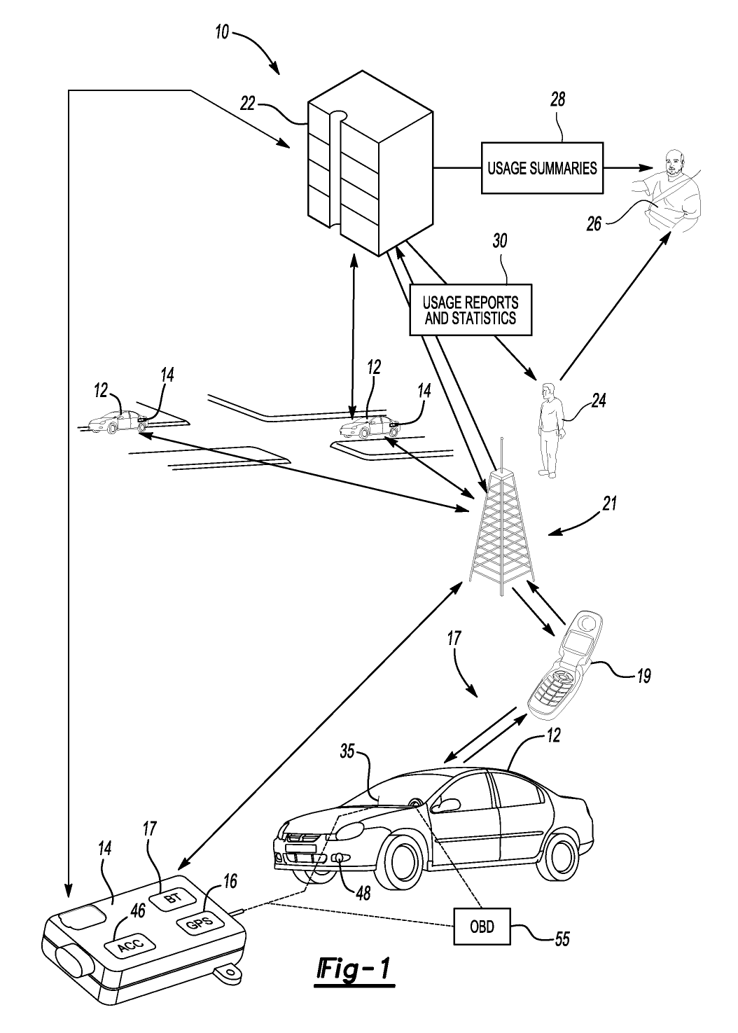

Referring to FIG. 1, a schematic representation of the system 10 is shown and includes a plurality of vehicles 12 with a one or more vehicle units 14 installed within the vehicle (three are shown, but it is contemplated that the vehicle units 14 would be installed in thousands of vehicles in an area). The vehicle unit 14 is attached and connected to receive power from a vehicle power source. Power from the vehicle can originate from a non-switched fuse box, OBD-II port 55, or other powered connection within the vehicle 12 as known. The vehicle unit 14 includes a processor and storage and is suitably programmed to perform the functions described herein.

Each vehicle unit 14 includes at least one wireless communication circuit 17, such as a Bluetooth communication circuit, GPRS, WiFi, WiMax, cell phone, satellite phone or other wireless communication protocol, or more than one protocol. If the wireless communication circuit 17 includes Bluetooth (or equivalent), it communicates with a wireless device 19, which is preferably a smart PDA or other portable wireless communication device 19 in order to communicate with cell towers 21. In this manner, the vehicle units 14 are able to exchange information with a server 22. The vehicle units 14 are further able to directly connect to the server 22 to communicate information regarding the vehicle 12 and receive information directly from the server relating to other characteristics. The server 22 includes at least one computer processor, and computer storage device. In addition, in one embodiment, more than one server can be connected via known methods, to share information. In another embodiment, the more than one servers can divide the processes such that a first server collects data and transmit it to second server which processes it and creates a report.

The system 10 has the ability to determine the location of each of the vehicle units 14 using any of numerous existing techniques (or several). First, the vehicle unit 14 may include a GPS receiver 16. Location can be determined from a global navigation satellite system, GSM locatilization, DSRC, WiMAX, or other known methods. The GPS receiver can send the vehicle 12 location to the vehicle unit 14 and the server 22. Alternatively, or additionally, the server 22 can determine the positions of the devices 19 using GPRS triangulation from cell towers 21. Using cell tower triangulation, the location of the device 19 is determined at the servers 22 and can remain at the server 22 or can also be transmitted to the vehicle unit 14. Optionally, the vehicle unit 14 can include a three-axis accelerometer 46 for determining an acceleration or deceleration of the vehicle 12, from which speed and position information can be determined. The accelerometer 46 can also determine that a collision has occurred and can determine driving habits of the driver (e.g. hard accelerations or decelerations). The vehicle unit 14 also receives speed and heading information from the On Board Diagnostics port OBD 55. Speed and heading can be used to determine location of the vehicle unit 14.

However the location of the vehicle units 14 (and vehicles 12) is determined, the location and the time in certain geographic areas (e.g. zip codes) can be used to determine insurance rates in several ways. Some insurance premiums are based upon miles driven and based upon geographic areas in which the miles are driven. The premiums may also be based upon the driver's driving habits, such as hard accelerations, speed, time of day, day of the week, and type of roads among others.

Car emission data, such as real time emission levels, can be obtained by the vehicle unit 14 from the OBD 55. The vehicle unit 14 can receive emission level readings from the OBD and send the emission levels, with tags indicating the time and location of each reading, to the server 22 in the ways listed to be stored by the server 22. In one embodiment, the vehicle unit 14 can send the information at pre-set time intervals. Alternatively, real time data can be continually uploaded from the vehicle unit 14 to the server 22, or on demand whenever needed.

Each car may optionally include external environmental sensors, such as CO₂, CO, particulate, etc. sensor 48. The sensors 48 send information about external environmental conditions, with tags indicating the time and location of each reading, to the vehicle unit 14 for transmission to the server 22. Alternatively, these sensors 48 can send information about detected crash events by the vehicle 12 to the vehicle unit 14 for transmission to the server 22.

In a geographic area, if a large number of vehicles 12 include the vehicle units 14, the server 22 can gather data that is useful for environmental, traffic and other purposes. Alternatively, if only a small number of vehicles 12 include the vehicle units 14, data for that geographic area can begin to be accumulated by the server 22 while individual car information is also stored. The server 22 gathers real-time information about locations of the vehicles, their speed at their locations, excessive speed events, sudden speed changes, acceleration, excessive acceleration, sudden acceleration changes, crash events, car emission data (CO₂, etc.). The server 22 can compile the driving characteristics to generate real-time reports or historical averages and trends 30, such as, but not limited to the following:

1. Compute the aggregate of emissions from all vehicles 12.

The server 22 is able to produce statistics and reports 30 based on the overall emissions level for all vehicles 12 connected via the vehicle unit 14. In one embodiment, governmental and environmental agencies would be able to use these reports 30 to determine the overall effectiveness of emissions reduction programs as well as examine future needs in the field.

2. Compute the aggregate of emissions from vehicles 12 within a certain geographical zone.

The server 22 is able to take the recorded data from vehicles 12 and compile it into data for any set geographic area, such that the aggregate can be easily computed by the server 22 for any selected geographic area. In one embodiment, this allows the server 22 to produce statistics and reports 30 of changes in emission levels from year to year, or in real time, over the same geographic zone. In another embodiment, the server 22 can produce statistics and reports 30 comparing different geographic zones to determine their emission levels and contributions.

3. Compute the aggregate of emissions from vehicles 12 within a certain geographical zone during a certain period of time.

The server 22 is able to take recorded data from vehicles 12 and compile it into data for any set geographic area over any set period of time, such that the aggregate can be easily computed for any adjusted geographic area. In one embodiment, this allows the server 22 to produce reports 30 of changes in aggregate emission levels for any preset time period, such as months, weeks, or several years. In another embodiment, real time data can be compared at certain time periods, such as time of day, to determine applicable emissions levels.

4. Compute aggregate of emissions from vehicles 12 within a certain road segment for a certain period of time.

The vehicle unit 14 is able to send the location of the vehicle 12 to the server 22, or alternatively, the server 22 is able to receive the location from a GPS system 16 directly, In one embodiment, the server 22 produces a report 30 of the aggregate of all real time data of emissions from any car found to be within a certain road segment. In another embodiment, aggregate data determined by the server 22 can be used to compare emissions on different road segments for environmental or insurance purposes.

5. Compute aggregates of emissions of a certain vehicle 12 brand.

In another embodiment, the server 22 is able to create statistics and reports 30 on aggregate emission levels based on the vehicles 12 brand, as such information can be relayed from the vehicle unit 14 pre-set with the information or alternatively via the OBD 55. The server 22 can alternatively, create reports and statistics 30 based on comparisons of the aggregate emission levels of different vehicle 12 brands.

6. Compute crash frequency within a certain geographical area, for a certain period of time.

The server 22 is able to create statistics and reports 30 based on crash events in any particular geographical area, based upon the location of the vehicle 12 and the reporting of a crash event. In one embodiment, the vehicle unit 14 delivers the real time location information of the vehicle 12, and through one of numerous methods, is informed of a crash event, transmitting this information to the server 22. The server 22 records the crash event and real time location of the vehicle 12 when the event is transmitted. The server 22 then creates a record of the crash events during a particular time and in a particular geographic area based on what has been transmitted to it from numerous vehicle units. In another embodiment, the particular time can be considered to be a time of day, with or without the geographic area restriction. In another embodiment, the server 22 can cross reference the recorded crash events, with time and location tags, and show the effect on nearby traffic and emissions by cross-referencing the crash events.

7. Compute average speed, speed variances, accelerations, acceleration variation, sudden acceleration/deceleration frequency of vehicles within a certain geographical area and a certain period of time.

The server 22 is able to compute a large number of driving characteristics from information about the vehicle 12, such as average speed, speed variances, accelerations, acceleration variation, and sudden acceleration/deceleration frequency. In one embodiment, the vehicle unit relays one or more characteristics about the vehicle 12 continually over a period of time, while the vehicle 12 is in a certain geographical location. The aggregate of this information from many vehicles 12 can then be incorporated by the server 22 into statistics and reports 30 showing, for example, correlation between increased average speed and crash events, or in another example, increased acceleration variation and emission output. The server 22 could also create statistics showing the correlation between acceleration an crashes, crashes and emissions, or any number of driving characteristics.

8. Estimate car density as function of location and time.

The vehicle unit 14 is providing the server 22 with real time location and time of each individual vehicle 12. In one embodiment, the server 22 compiles a first report 30 determining the amount of vehicles 12 in any particular geographic location at or during any specific time period. In another embodiment, the server 22 compiles a second report 30 internally using the data of the second report to determine any correlation or relation to crash events.

9. Project traffic congestion

Traffic congestion and traffic conditions for a given road segment can be real-time predicted based on historical speed/acceleration profiles for the segment fused with real-time information gathered by pooling current speed and acceleration readings from a select group of vehicles 12 known to be driving on the segment. In this case the server 22 will send a message to vehicles 12 in the area asking them to report their current speed and acceleration values for a period of time starting at current time back in the past for a certain period of time. This information is combined with historical data for the segment to determine traffic conditions, an estimate of how long a certain traffic condition will last and for how far on the segment. Processing of reported acceleration instances in conjunction with speed limits along the segment and other road segments in the area can help deduce if a crash took place, where on the road segment a certain traffic condition is expected to change (e.g, end of traffic jam condition). This information can be communicated to the vehicles 12 in the surrounding area, so that the vehicle's driver or the vehicle's navigation system can determine whether to avoid the particular road segment.

10. Project all above into zip code maps.

The server 22 records and saves all of the information sent to it by the vehicle unit 14. The server 22 compiles statistics and reports 30 on driving characteristics including, but not limited to, crash events, average speed, speed variances, accelerations, acceleration variation, sudden acceleration/deceleration frequency, and emissions outputs based upon their occurrences in different zip codes. The server 22 provides the aggregate report per zip code or other geographic boundaries for any information requested by users 24.

The statistics and reports 30 compiled by the server are then reported to multiple parties 24. As stated previously, they can be used to improve pricing on insurance premiums. They can further be used to report information such as traffic density, detect crash events and mapping emissions geographically, information which is useful to numerous parties for a multitude of reasons.

These reports can also be delivered in terms of usage summaries 28 and given to the driver of vehicles 12 to improve performance. For example, as an alternative to periodic emissions testing for vehicles 12, the server 22 can detect a particular condition in the vehicle from the information received by the vehicle unit 14 from the OBD 55 and instruct the owner of the vehicle 12 to bring the vehicle 12 to a certified testing station for emissions testing.

Further, the server 22 can also use the external environmental sensors 48 on vehicles 12 for real-time samples of environmental conditions in geographic areas. The information can be used to help focus efforts at reducing emissions or reducing traffic and improving traffic flow.

Thus reports can be used to improve solutions including, but not limited to reducing emissions in a geographic area, improving traffic flow, reducing crash events, monitoring excessive speed, and setting insurance premiums.

Although a preferred embodiment of this invention has been disclosed, a worker of ordinary skill in this art would recognize that certain modifications would come within the scope of this invention. For that reason, the following claims should be studied to determine the true scope and content of this invention.

1. A system for collecting data from many vehicle comprising:
at least one server programmed to receive driving characteristic information from many vehicles, the at least one server recording the information, and producing reports of the information in response to requests from a user.

2. The system of claim 1, wherein said driving characteristic information and said report include emissions information from more than one vehicle.

3. The system of claim 2, further including a vehicle unit in each of the vehicles, wherein the vehicle unit includes a communication means operable to transmit information to the at least one server.

4. The system of claim 3, wherein the vehicle unit includes a processor and storage.

5. The system of claim 4, wherein the driving characteristics transmitted by the vehicle units further include crash events.

6. The system of claim 4 wherein the driving characteristics transmitted by vehicle units further include speed, location, and acceleration information.

7. The system of claim 4, wherein the vehicle unit receives real time emission levels from an On-Board Diagnostics port and transmits the emissions levels to the at least one server.

8. The system of claim 4, wherein the vehicle includes external sensors relaying external conditions to the vehicle unit.

9. The system of claim 4, wherein the vehicle unit includes a global positioning system receiver.

10. The system of claim 4, wherein the vehicle unit includes an accelerometer.

11. The system of claim 4, wherein the vehicle unit includes a wireless communication circuit.

12. The system of claim 11, further including the vehicle unit sending driving characteristic information to the at least one server by wirelessly connecting to a cellular tower, connected to the at least one server, using a cell phone.

13. The system of claim 7, wherein said reports include emissions mapped geographically.

14. The system of claim 7, wherein said reports include data regarding emissions information crossed with at least one of the following: vehicle brand, geographic area, time of day, crash frequency, average speed, speed variances, accelerations, acceleration variation, sudden acceleration frequency, sudden deceleration frequency, and car density.

15. A method for collecting data from a vehicle comprising:
(a) receiving driving characteristic information from a plurality of vehicles in at least one server;
(b) generating a report of statistics and trends by the at least one server based upon the driving characteristic information in response to a request, and
(c) presenting said report from the at least one server to a user.

16. The method of claim 15, wherein driving characteristic information includes emissions information from the vehicles.

17. The method of claim 15, wherein step (c) further includes a report on emission information being sent to a driver of one of the vehicles.

18. The method of claim 15, further including the step of sending reports to a driver.

19. The method of claim 15 wherein step (a) includes the step of receiving speed and acceleration information from the plurality of vehicles, and further including the step of generating the report in said step (b) based upon the speed and acceleration information of the plurality of vehicles on a road segment and based upon historical information of traffic on the road segment.

20. The method of claim 19 further including the step of predicting when traffic conditions will change based upon the speed and acceleration information of the plurality of vehicles on the road segment and based upon the historical information of traffic on the road segment, and sending the prediction to a plurality of vehicles other than the plurality of vehicles on the road segment.
